(19) United States
(12) Patent Application Publication
(10) Pub. No.: US 2005/0135185 A1
(43) Pub. Date: Jun. 23, 2005

(54) System and method for forming a slurry

(76) Inventors: Alan B. Duell, Duncan, OK (US); Paul A. Brown, Duncan, OK (US); Perry A. Jones, Comanche, OK (US); Troy Bachman, Duncan, OK (US); Rodney E. McCauley, Comanche, OK (US); Joseph K. Maxson, Rawlins, WY (US)

Correspondence Address: JOHN W. WUSTENBERG, P.O. BOX 1431, DUNCAN, OK, 73536, US

(21) Appl. No.: 10/982,993

(22) Filed: Nov. 5, 2004

Related U.S. Application Data
(63) Continuation-in-part of application No. 10/085,443, filed on Feb. 28, 2002, now abandoned.

(51) Int. Cl. B28C 7/04

(52) U.S. Cl. 366/8; 366/152.2

(57) ABSTRACT

A method of forming a mixture of two or more elements for discharge from a vessel. The change in the volume of the mixture in the vessel, as well as the flow of at least one of the elements and the mixture are measured so that the flow of an unmeasured element into the vessel can be calculated.

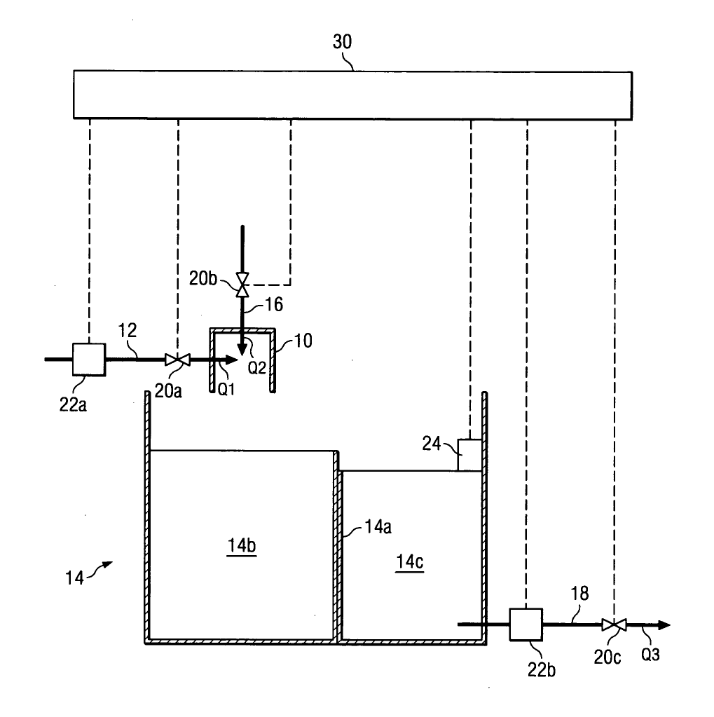

### CROSS-REFERENCE TO RELATED APPLICATION

This application is a continuation-in-part application of co-pending application Ser. No. 10/085,443 filed Feb. 28, 2002.

### BACKGROUND

In the drilling of oil and gas wells, a casing is usually placed in the well and cement, or other similar material, is mixed with a liquid, such as water, at the surface to form a slurry which is pumped down hole and around the outside of the casing to protect the casing and prevent movement of formation fluids behind the casing. The mixing is typically done by mixing the cement ingredients, typically cement, with water, chemicals, and other solids, until the proper slurry density is obtained, and then continuing to mix as much material as needed at that density while pumping the slurry down hole in a continuous process. Density is important since the resulting hydrostatic pressure of the slurry must be high enough to keep pressurized formation fluids in place but not so high as to fracture a weak formation.

Some wells require lightweight slurries that will not create enough hydrostatic pressure to fracture a weak formation. One way of creating light-weight slurries is to use low specific gravity solids in the blend. The problem with such slurries is that the density of the solids can be close to, or the same as, the density of the slurry. When this happens, the ratio of solids to liquid can change significantly with little or no change in slurry density. Changes in solids-to-water ratio can affect slurry viscosity, compressive strength, and other properties. In these situations, density-based control systems do not work well.

As a result of the above it is important to be able to measure the flow rates of the liquid, the solids, and the slurry so that the density of the slurry can be determined and controlled. However, the flow rate of the solids can not be measured directly.

Therefore, what is needed is a system and method for creating a slurry of the above type that overcomes the above problems.

### BRIEF DESCRIPTION OF THE DRAWING

The drawing is a schematic diagram depicting a system according to an embodiment of the present invention.

### DETAILED DESCRIPTION

Referring to the drawing, the reference numeral 10 refers to a mixing head which receives a quantity of liquid, such as water, from a flow line 12 at a continuous volumetric flow rate Q1. The mixing head 10 communicates with a vessel 14 that includes a partition 14a that divides the vessel into a first portion 14b which receives the liquid from the head 10, and a second portion 14c. The height of the partition 14a is such that the liquid flows, by gravity, from the first vessel portion 14b to the second vessel portion 14c.

A quantity of solids, such as cement and possibly other chemicals, is passed from an external source, via a flow line 16, into the mixing head 10 at a continuous volumetric flow rate Q2. The liquid and the solids flow from the head 10 to the vessel portion 14b and mix to form a slurry that flows into the vessel portion 14c before discharging from an outlet in the vessel portion 14b through a flow line 18 at a continuous volumetric flow rate Q3.

Three flow valves 20a, 20b, and 20c are mounted in the flow lines 12, 16, and 18, respectively, and operate in a conventional manner to control the liquid flow rate Q1, the solids flow rate Q2, and the slurry flow rate Q3, respectively, in a manner to be described. It is understood that actuators, or the like (not shown), may be associated with the valves 20a, 20b, and 20c to control, in a conventional manner, the positions of the valves, and therefore the rates Q1, Q2, and Q3.

Two flow meters 22a and 22b are disposed in the flow lines 12 and 18, respectively, upstream of the valves 20a and 20c, respectively, and measure the flow rates Q1 and Q3, respectively. The meters 22a and 22b are conventional and could be in the form of turbine, magnetic, or Coriolis meters.

A measuring device 24 is provided in the vessel portion 14c for measuring the level of the slurry in the vessel portion. The device 24 can be one of several conventional devices that are available for measuring liquid level including, but not limited to, radar, laser, or ultrasonic devices.

The volume of slurry in the vessel portion 14c is determined by monitoring the level of the slurry in the vessel portion and calculating the volume of slurry in the vessel portion utilizing the measured value and the vessel dimensions, or geometry, in a conventional manner. The slurry level in the vessel portion 14c is monitored continuously so that any changes in the slurry volume with respect to time can be determined.

An electronic control unit 30 is provided that includes a microprocessor, or the like, and is electrically connected to the valves 20a, 20b, and 20c, the meters 22a and 22b, and the measuring device 24. Since the control unit 30 can be one of a number of conventional devices, it will not be described in great detail and its operation will be described below.

In operation, liquid is introduced at a rate Q1 into the head 10 while solids are introduced at a rate Q2. The liquid and the solids mix in the head 10 to form a slurry that flows into the vessel portion 14b, and then, by gravity, into the vessel portion 14c before discharging from the latter vessel portion at a rate Q3. The meters 22a and 22b meter the flow rates Q1 and Q3, respectively, while the measuring device 24 measures the slurry level in the vessel portion 14c. Electrical signals from the meters 22a and 22b, corresponding to the flow rates Q1 and Q3, and signals from the measuring device 24, corresponding to the slurry level in the vessel portion 14c, are passed to, and processed in, the control unit 30.

The control unit 30 calculates the change in the volume of the slurry in the vessel portion 14c, and sends corresponding signals to the valves 20a, 20b, and 20c to control the flow through the valves, and therefore the rates Q1, Q2, and Q3, accordingly.

Although the flow rate at which the solids are being added to the vessel 14 cannot be measured directly, the flow rate can be determined by performing a volume balance on the vessel 14. The volume balance involves the following equation:
Q1+Q2=Q3+dV/dT
Where:
Q1=flow rate of the liquid into the mixing head 10 (in terms of volume per unit time, e.g. gallons per minute)
Q2=flow rate of the solids into the mixing head 10 (in terms of volume per unit time, e.g. gallons per minute)
Q3=flow rate of the slurry discharged from the vessel portion 14c (in terms of volume per unit time, e.g. gallons per minute)
V=volume of slurry in the vessel 14 (in terms of gallons)
T=time
dV/dT=change in volume of the slurry in the vessel 14 with respect to time (in terms of volume per unit time, e.g. gallons per minute).
   Thus:
   Q2=Q3−Q1+dV/dT

As a result, continuous measurement of dV/dT enables the flow rate Q2 of the solids into the head 10, and therefore into the vessel 14, to be determined on a continuous basis, allowing the operator or the control unit 30 to adjust and maintain the solids flow rate Q2 at a desired value.

If it is desired for the solids flow rate Q2 to be proportional to either the liquid flow rate Q1 or the slurry discharge flow rate Q3, then the solids flow rate Q2 could be maintained as a percentage of either of the liquid flow rate Q1 or the slurry flow rate Q3. Alternatively, the solids flow rate Q2 could be maintained at a desired value independent of the liquid flow rate Q1 or the slurry discharge flow rate Q3, or the system could be used as a solids flow meter to simply measure the solids flow rate without any attempt to control the rate to a given value.

It is also possible (but not necessary) to control the ratio of the liquid flow rate Q1 to the slurry discharge flow rate Q3 simultaneously with the solids flow rate Q2. For example, if a solids slurry is being mixed where the desired slurry was X% liquid and Y% solids, the liquid flow rate Q1 and the solids flow rate Q2 could be maintained at the rates:
Q1=(X/100)×Q3
Q2=(Y/100)×Q3

If it were desirable to maintain the solids flow rate, Q2, as a percentage, Z%, of the liquid flow rate, Q1, then the solids flow rate could be maintained at the rate calculated by:
Q2=(Z/100)×Q1
In this case, the relationship of Q1 to Q3 would not need to be maintained at a specified ratio.

Other combinations of inflow and outflow proportions could be controlled.

Thus, according to the above, it is not necessary to maintain a certain ratio between Q1 and Q3 (although it can be done), and the solids can be added at a rate that is independent of one or both of the other rates, Q1 and Q3. Also, the solids flow rate Q2 can be determined and controlled during non-steady state conditions, i.e. when the level of the vessel portion 14c (and therefore the vessel volume) is fluctuating. Further, manual control can be utilized if the automatic control of one or more of the flow rates Q1, Q2, and Q3 cease to function.

In the event partial automatic control is desired, the flow rates Q1 and Q3 could be measured by the meters 22a and 22b, respectively, and the valves 20a and 20c controlled accordingly by the control device 30 as described above, while the solids rate, Q2, could be controlled manually. Alternatively, Q3 could be controlled manually while Q1 and Q2 are controlled automatically by the control device 30. Other combinations of partial and manual control are possible.

If it is desired to control the entire process manually, Q1, Q2, and Q3 would be observed by an operator, preferably on a numeric display, and the operator would set the rates to maintain the proper ratios and mixing rate.

It is understood that variations may be made in the foregoing without departing from the scope of the invention. For example, the number and the type of elements forming the slurry can be varied within the scope of the invention and do not have to include solids.

Although only one exemplary embodiment of this invention has been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims.

1. A method comprising the steps of:
introducing two or more elements into a vessel;
forming a mixture of the elements;
discharging the mixture from the vessel;
determining the change in the volume of the mixture in the vessel;
measuring the flow rate of at least one of the elements and the mixture; and
utilizing the measured flow rates and the change in the volume of the mixture in the vessel to determine the flow rate of one other of the elements into the vessel.

2. The method of claim 1 further comprising the step of controlling the flow rate of one of the elements based on the determined flow rate of another of the elements.

3. The method of claim 2 wherein the step of measuring comprises providing meters in flow lines of the elements and the mixture, and wherein the step of controlling comprises providing valves in the flow lines of the elements and the mixture.

4. The method of claim 3 wherein the step of controlling comprises connecting a control unit to the meters and the valves for controlling the opening of the valves in response to the measuring.

5. The method of claim 1 wherein the step of forming a mixture comprises introducing the elements into a mixing head to form a slurry before introduction into the vessel.

6. The method of claim 1 wherein the change in the volume of the mixture is determined based on the dimensions of the vessel.

7. The method of claim 1 wherein one of the elements is a liquid and another of the elements is a solid.

8. The method of claim 7 wherein the liquid is water and the solid is cement.
